(19) United States
(12) Patent Application Publication
(10) Pub. No.: US 2006/0180527 A1
(43) Pub. Date: Aug. 17, 2006

(54) Device to separate particles of solids and high-density fluids from fluids of lower-density

(75) Inventors: Otto Blaschke, Vienna (AT); Josef Klems, Datteln (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: Willibrord Loesing Filterproduktion GmbH, Hattingen (DE)

(21) Appl. No.: 11/206,917

(22) Filed: Aug. 19, 2005

(30) Foreign Application Priority Data
Sep. 15, 2004 (EP) 04 021 901.6

(51) Int. Cl. B01D 21/24

(52) U.S. Cl. 210/97; 210/232; 210/513; 100/104; 100/110; 210/519

(57) ABSTRACT

A device to separate particles of solids and high-density fluids from fluids of lower density, whereby a casing, equipped with an inlet channel and outlet in the central section, upper lid structure and cup-shaped bottom part form a longitudinal chamber. The lid structure consists of an operating element, a suspension bridge and a lid. The suspension bridge can be attached to the central section through operation of the operating element. The operating element pushes through the suspension bridge. The lid, which is located underneath the suspension bridge, is allowable by the operating element through further operation of the operating element and it can be pressed onto the central section. A pressing element that rests on the lid pushes the filter element against a base.

### BACKGROUND OF THE INVENTION

1. Field of the Invention

The invention concerns a device to separate particles of solids and high-density fluids from fluids of lower density whereby a casing containing a central element with an inlet channel and outlet, an upper lid and cup-shaped bottom part form a longitudinal chamber. The bottom part of the latter contains a redirection separator. A filter element is located in the central section whereby a pressing element, which supports the lid, pushes the filter element against a base.

2. Description of Related Art

A device of the aforesaid nature, upon which the invention is based, is known from EP 0 416 146 B1. In the case of this known device, the lid structure simply consists of a single lid that is screwed onto the central section of the casing by means of multiple screws. Basically, this known device has proven its worth.

The invention is based on the technical problem of specifying a device of the initially named nature which is equipped with a lid structure that can be easily closed and opened and with which an efficient and sure-to-function operation is guaranteed nevertheless.

### SUMMARY OF THE INVENTION

In order to solve the technical problem, the invention concerns a device to separate particles of solids and high-density fluids from fluids of lower density whereby a casing containing a central element with an inlet channel and outlet, an upper lid and cup-shaped bottom part form a longitudinal chamber.

The bottom part contains a redirection separator and a filter element is located in the central section. The lid structure is equipped with an operating element, a suspension bridge and a lid, whereby the suspension bridge is fixable to the central section through actuation of the operating element, whereby the operating element punches through the suspension bridge and whereby through further actuation of the operating element the lid, which is located underneath the suspension bridge, is allowable and can be pushed onto the central section, and whereby a pressing element, which supports the lid, is pushing the filter element against a base.

The fact that the suspension bridge is located above the lid lies within the scope of the invention. Furthermore, the fact that both the lid and the suspension bridge are shaped platy is also within the scope of the invention. Both the lid and the suspension bridge are essentially manufactured in rectangular shape according to an embodiment of the invention. Advantageously, the lid surface corresponds approximately to the surface of the suspension bridge.

According to the preferential embodiment of the invention, the suspension bridge is fixed to the central section of the casing by means in the form of a bayonet socket by means of an initial rotating of the operating element. The suspension bridge rotates jointly with the operating element when this operating element is rotated for the first time. For this purpose, a form-fitting coupling between the operating element and suspension bridge is advantageously provided in the punch-through area of the operating element. There is no relative torsion between the operating element and the suspension bridge during the initial rotation of the operating element.

On the contrary, the operating element and the suspension bridge rotate jointly in the fixed position and in the bayonet socket position of the suspension bridge, respectively.

Preferably, fixation hooks are mounted on the outside of the suspension bridge. These fixation hooks can be transferred from a free position to a bayonet socket position during the initial rotation of the operating element and the suspension bridge, respectively, in which bayonet socket position these fixation hooks at the central section of the casing lock and toggle attached fixation ledges. The bayonet socket position concerns the fixed position of the suspension bridge. The fact that at least one impact element is provided, which impact element blocks an additional rotation of the suspension in the direction of the initial rotation, is within the scope of the invention. According to the preferred embodiment of the invention, at least one fixation ledge of the central section is designed as an impact element to block further rotation of the suspension bridge. In other words, a further torsion of the suspension bridge is no longer possible in the fixed position and bayonet socket position, respectively. Admittedly, a rotation in the opposing direction is possible, as a result of which the suspension bridge can be detached from the central section. The fact that at least two fixation hooks are provided at the suspension bridge is within the scope of the invention. When the suspension bridge, according to the preferred embodiment of the invention, is rectangular and essentially rectangular in shape, a fixation hook is advantageously available at each corner of the rectangle and assigned fixation ledges are connected to the central section according to the fixation hooks.

Preferably, the operating element shows a manipulating element protruding from the suspension bridge. Advantageously, this manipulating element can be manually created and, subsequently, the operating element can be contorted accordingly.

The fact that the operating element and manipulating element of the operating element, respectively, can be simply operated by hand or without any tools fits the scope of the invention.

According to a very preferred embodiment of the invention, the operating element pressurizes the lid during a second torsion of the operating element in the fixed position of the suspension bridge. Consequently, the lid is pressed onto the central section of the casing. The fact that this second rotation of the operating element takes place in the same rotating direction as is the case for the initial rotation of the operating element fits the scope of the invention. The suspension bridge is secured against simultaneous rotating in the fixed position of the suspension bridge for the purpose of which the abovementioned impact element is preferentially provided. A relative torsion of the operating element to the suspension bridge takes place during the second rotation of the operating element.

Preferably, the operating element which punches through the suspension bridge is designed as screw element. The latter shows an external screw thread and a hole in the suspension bridge, which adopts the operating element, demonstrates an internal screw thread that interacts with the external screw thread of the operating element. According to this preferred embodiment, the operating element is screwed quasi into the suspension bridge and exerts thereby pressure on the lid. The fact that in the case of the screwed in operating element the lid seals the central section and the casing, respectively, fits the scope of the invention. As displayed above, the suspension bridge is secured against a simultaneous rotation, namely advantageously by means of previously explained impact elements.

Advantageously, the pressing element rests resiliently on the lid. For this purpose, preferably at least one spiral spring is located between the lid and the pressing element.

According to a very preferred embodiment of the invention, four spiral springs are available between the lid and pressing element, whereby the respective four spiral springs are connected to the four corners of the rectangular lid, as well as to four corners of rectangular pressing frame (pressing element). The spiral springs rest on both the bottom part of the lid and on the pressing frame.

According to a preferred embodiment of the invention, a lockable vent hole is provided in the lid and the suspension bridge shows at least one entry hole aligned with the vent hole of the lid in the fixed position of the suspension bridge. An inlet to the vent hole in the lid is also guaranteed in this way in the fixed position of the suspension bridge. Advantageously, the vent hole in the lid can be locked with the vent screw. The fact that two or more entry holes are provided in the suspension bridge fits the scope of the invention. Consequently, an inlet to the vent hole is guaranteed in each position of the suspension bridge in its fixed position.

The invention is based on the perception that the lid structure of the device according to the invention enables a very easy and little complex locking and opening of the casing. The device can be assembled in a very quick manner and made sure to function, whereby it can simply be manually operated Without aids such as tools or the like being necessary. The fact that a specific, precise and consistent influence on the filter element takes place in the embodiment according to the invention is particularly important in the scope of the invention. When the operating element is screwed into the suspension bridge and the lid is pressurized by the operating element correspondingly, the lid can continuously and equally influence the filter element which pushes the impact element.

Simultaneously, the casing is also equipped with a seal that is sure to function. As a result, a very precise and equal surface pressure can be exercised on the filter element in comparison to similar devices from the status of technology. Surprisingly, this also leads to an improvement of the filter operation of the device.

Advantageously, the filter element in the central section is located above the inlet channel. The redirection separator from the lower end preferably consists of a guided tube that is connected to the inlet channel. This guided tube preferably stretches along the chamber axis with a distance from the bottom part to a part of its height into the bottom part. According to a preferred embodiment, the guided tube and a screwing body element, which is located in the guided tube, together constitute a spiral flow channel with bottom fluid outlet holes.

### BRIEF DESCRIPTION OF THE DRAWINGS

Hereinafter the invention is further clarified based on an image describing the embodiment. The following is shown in a schematic view:

FIG. 1 is a sectional drawing of the device according to the invention;

FIG. 2 is a view from above of the device according to the invention; and

FIG. 3 is the device according to FIG. 2 without lid structure.

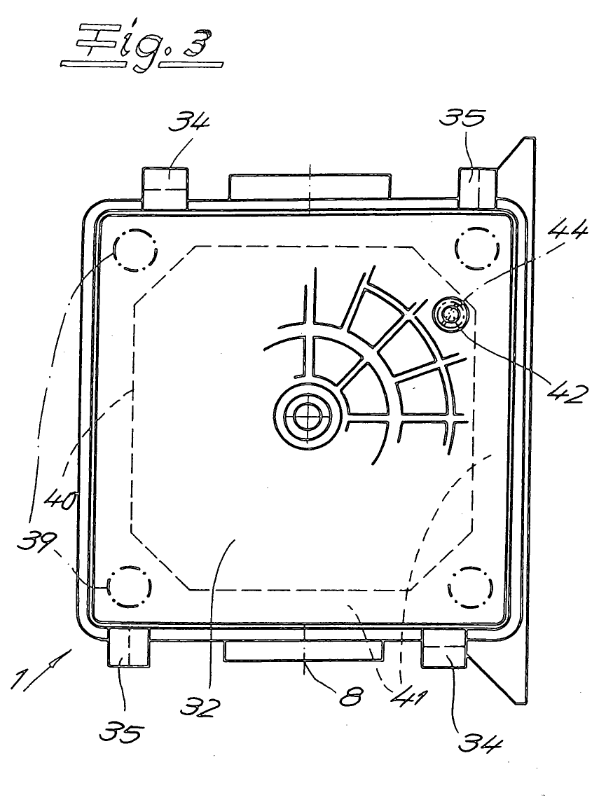

### DETAILED DESCRIPTION OF THE PREFERRED EMBODIMENTS

The figures show a device to separate particles of solids and high-density fluids from fluids of lower density. The device for example is used to separate dirty particles and water from fluid combustibles such as gas and diesel and heating oil, respectively.

The device contains a casing 1 which consists of a central section 2, an upper lid structure 3 and a cup-shaped bottom part 4 and builds a longitudinal chamber 5. A redirection separator 6 is positioned in bottom part 4. A filter inlet 9 is installed above inlet channel 7 in central section 2, which is equipped with an inlet channel 7 and an outlet 8.

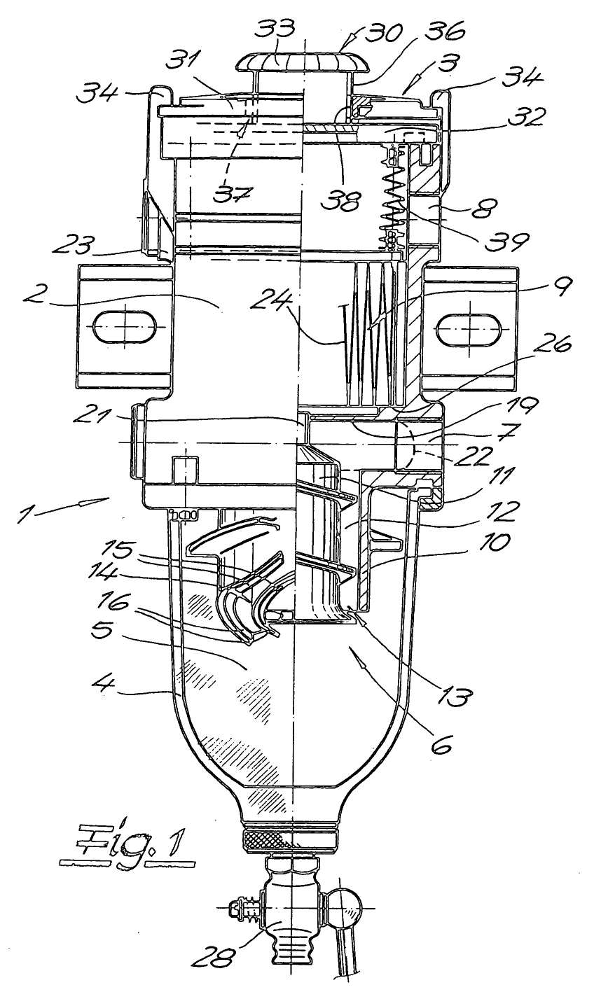

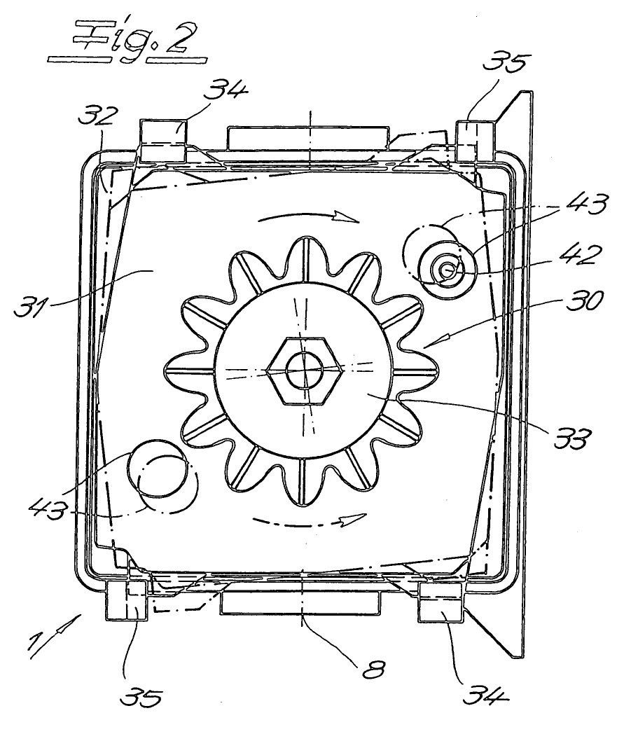

It can be gathered from FIGS. 1 and 2 that the lid structure 3 consists of an operating element 30, a suspension bridge 31 and a lid 32. It is noticeable that the suspension bridge 31 is located above the lid 32. Both the suspension bridge 31 and the lid 32 are platy in design. The lid 32 has a rectangular shape in the embodiment and also the suspension bridge 31 has essentially a rectangular shape in the embodiment. Advantageously, the surface of the suspension bridge 31 essentially corresponds to the surface of the lid 32 in the embodiment. According to the preferred embodiment, the suspension bridge 31 and the lid 32 are interconnected by means of a detachable bosh and clip connection, respectively. This is not demonstrated in the figures. In other words, the lid 32, suspension bridge 31 and operating element adopted in the suspension bridge constitute a part and structural unit, respectively, so that the assembly is relatively simple and user-friendly.

The fact that the suspension bridge 31 can be fixed to the central section 2 of casing 1 with a bayonet socket through an initial rotation of the operating element that punches through the suspension bridge 31 fits the scope of the invention. Advantageously, the operating element 30 demonstrates a manipulating element 33 protruding from the suspension bridge in the form of turning knob so that the operating element 30 can easily be operated and rotated, respectively, by hand and without the aid of tools. The suspension bridge 31 rotates with the operating element 30 during the initial rotation of the operating element 30.

This is taken care of by a form-fitting connection, which is further clarified below, in the punch-through area between the operating element 30 and the suspension bridge 31. In other words, there is no relative rotation between the operating element 30 and the suspension bridge 31 during the first rotation of the operating element 30. Instead, there is a collective rotation of the “free” position of the suspension bridge 31 in the fixed position and bayonet socket position, respectively, of the suspension bridge 31. The free position in FIG. 2 is clarified by means of a chain dotted line while the fixed position is shown as drawn through. The suspension bridge 31 can be contorted to the right in the direction of the drawn through arrow from the free position into the fixed position.

Preferably, fixation hooks 34 are connected to the corners of the suspension bridge 31. These fixation hooks 34 can also be transferred from the free position to the bayonet socket position during the initial rotation of the operating element 30, in which bayonet socket position the fixation hooks 34 lock in fixation ledges 35 which are attached to the central section 2. Furthermore, the fact that impacts are at hand, which block further rotation of the suspension bridge 31 in the direction of rotation, fits the scope of the invention. Two diagonally opposed fixation hooks 35 of the central section are designed in the embodiment as such impacts and block a further rotation of the suspension bridge 31.

In the case of the fixed position of the suspension bridge 31 (shown as drawn through in FIG. 2), an additional rotation of the suspension bridge 31 in the direction of the rotation of the first rotation is not possible anymore. Nevertheless, the operating element 30 can further contorted in this direction. A pressurization caused by the operating element 30 itself is exercised on the lid 32 during the second torsion of the operating element 30 in the fixed position of the suspension bridge 31. As a result, the lid 32 is pressed onto the central section 2. The operating element 30, which punches through the suspension bridge 31 is preferably designed as screw element in the embodiment.

For this purpose, the operating element 30 contains an external screw thread 36. Accordingly, the hole 37, which adopts the operating element, in the suspension bridge 31 features an internal screw thread interacting 38 with the external screw thread 36 of the operating element 30.

The suspension bridge 31 is secured against simultaneous rotating with the operating element 30 through impacts in its fixed position. The operating element 30 is quasi screwed into the suspension bridge 31 and has thereby an impact on the lid 32 during the second exclusive rotation of the operating element 30. In this manner, a very precise and equal surface pressure can be exercised on the filter element 9.

According to the invention a pressing element, which rests on the lid 32, presses the filter element 9 against a base 26. The pressing element preferably rests resiliently on the lid 32 in the embodiment. This resilient support occurs with the help of spiral springs 39 according to an embodiment. In principle, the fact that the resilient support can be realized with the help of elastomeric springs fits the scope of the invention. Preferably, a spiral spring 39 is attached to the four corners of the lid 32 whereby the spiral springs are connected to their opposite end at the four corners of a rectangular pinch frame 40. The latter consists in the embodiment of four pressing braces 41 which are located at the rectangular sides. Due to the second rotation of the operating element 30 and, consequently, due to the screwing in of the operating element 30 in the suspension bridge 31, the operating element 30 pressurizes the lid 32 which is again pressing the pinch frame 40 against the filter element 9 via the spiral springs. As clarified multiple times above, a very equal surface pressure is exercised on the filter element 9 and the structure surprisingly improves the functioning of the filter.

Advantageously, a lockable vent hole 42 is provided in the lid 32 in the embodiment. For this purpose, the suspension bridge 31 preferably features two entry holes 43. An entry hole 43 is aligned with the vent hole 42 in the fixed position of the suspension bridge 31. Both entry holes 43 in the suspension bridge 31 should guarantee that an entry to the vent hole 42 is ensured on the lid 32 during each starting position of the suspension bridge 31. The vent hole 42 is locked in the embodiment by means of a ventilation screw 44.

Advantageously, the redirection separator 6 of the device consists of a lower end of a guided tube that is connected to the inlet channel 7. This guided tube 10 stretches along the chamber axis with distance from bottom part 4 via a part the height of which to bottom part 4 and together with a screwing body element 11 located in guided tube 10 constitutes a spiral flow channel 12 with lower fluid outlet holes 13. Advantageously, two oppositely positioned fluid outlet holes 13 are realized. Preferably, the guided tube 10 features an external, V-shaped, guided separation feedback channel 14 at its lower end between both of these adjacent fluid outlet holes 13. Each of these separator feedback channels 14 consists of two frame angles 15 that run in opposite direction and reach until the wall of the bottom part 4. The respective lower V-handle 16 of the separator feedback channels features components running the direction of the spiral flow channels 12.

The inlet channel 7 is composed of a cross tube 19 (compare FIG. 1) which pushes through the central section 2. This cross tube 19 is locked or is lockable on one end so that there are multiple possibilities for feeding line that is not individually displayed. Advantageously, the central section 2, the cross tube 19 and the guided tube 10 form together a single casting. A screw 21, which is screwed into the cross tube 19 from above features the screw body element 11 in the guided tube 10. Furthermore, it can be gathered from FIG. 1 that the central section 2 in the area or at the height of the inlet channel 7 features a horizontally and circulatory internal chamfer 22 with graduated circular to partially elliptical cross-section as coalescence aid.

The outlet 8 is provided above the filter element 9 on the central section 2, namely immediately beneath the lid structure 3. As is the case for the inlet channel 7, the structure in this case can be as such that a locked or lockable insertion 23 on the opposite side is provided for an additional outlet. The casing 1 and the longitudinal chamber 5, respectively, feature circular-cylindrical cross-sections in the area of bottom part 4. The bottom part 4 itself can be made of transparent synthetics such as polycarbonate. However, if safety interests would require such, the bottom part 4 will be manufactured from aluminum just like all other parts of the device. Essentially, the casing 1 and the longitudinal chamber 5, respectively feature a rectangular cross-section in the area of the central section 2 while a quadratic cross-section is featured in the embodiment.

The functioning of the device can be described as follows: The fluid inflow through the inlet channel 7 flows between the guided tube 10 and the screw body element 11 downwards whereby a screw-shaped movement is made. After it has exited the fluid outlet holes 13, it is redirected upwards by 180° whereby the fluid drops of higher density sink to the bottom.

High-density drops that attach to the walls above the fluid outlet holes 13 will coalesce and will also be transported downwards into bottom part 4 through the separator feedback channels 14. The partial flows exiting the fluid outlet holes 13 will support this transport through suction. The coalescence effect also occurs in the area of the internal chamfer 22, as well as the side of the filter element 9 facing the bottom part 4. Finally, the dirty particles are retained in the filter element 9 and the fluid of lower density flows out through outlet 8. After interrupting the fluid inflow, the dirty particles and high-density fluid particles retained by the filter element are transported into bottom part 4 and from there through the discharge drain 28 in course of the sinking of the fluid level by means of opening the ventilation screws 44 and of the discharge drain 28.

Advantageously, the filter inlet 9 consists of paper, and the folds 24 of this filter element 9 are positioned parallel or vertical to the sides of the central section 2.

1. A device to separate particles of solids and high-density fluids from fluids with lower density, the device comprising:
a longitudinal chamber having a casing equipped with an inlet channel and an outlet in a central section thereof, an upper lid structure and a cup-shaped bottom part;
a redirection separator disposed in the cup-shaped bottom part of the longitudinal chamber; and
a filter element disposed in the central section, wherein
the upper lid structure includes an operating element, a suspension bridge and a lid,
the suspension bridge is attachable to the central section through operation of the operating element,
the operating element is configured to punch through the suspension bridge such that the lid positioned underneath the suspension bridge is pressed onto the central section by operation of the operating element, and
a pressing element is provided on the lid and is configured to push the filter element against a base of the central section.

2. The device according to claim 1, wherein the suspension bridge is attached to the central section via a bayonet socket through torsion of the operating element.

3. The device according to claim 2, wherein fixation hooks are connected to the suspension bridge; and the fixation hooks are transferred from a free position to a bayonet socket position during torsion of the operating element, in which bayonet socket position the fixation hooks lock and toggle fixation ledges connected to the central section.

4. The device according to claim 1, wherein a pressurization is exercised on the lid via the operating element during torsion of the operating element in a fixed position of the suspension bridge so that the lid is pressed onto the central section.

5. The device according to claim 4, wherein the operating element configured to punch through the suspension bridge is configured as a screw element and features an external screw thread; and a hole provided with the suspension bridge and configured to receive the operating element features an internal screw thread interacting with the external screw thread of the operating element.

6. The device according to claim 1, wherein the pressing element resiliently rests on the lid.

7. The device according to claim 6, wherein at least one spiral spring is disposed between the lid and the pressing element.

8. The device according to claim 1, wherein the pressing element is disposed as a rectangular pinch frame; and interconnected pressing braces are provided at rectangular sides of the rectangular pinch frame.

9. The device according to claim 1, wherein a lockable vent hole is installed in the lid; and the suspension bridge features at least one entry hole configured to be aligned with the vent hole of the lid in a fixed position of the suspension bridge.
